(19) United States
(12) Patent Application Publication
(10) Pub. No.: US 2024/0050957 A1
(43) Pub. Date: Feb. 15, 2024

(54) SYSTEM FOR CONTROLLING THE TEMPERATURE OF A MICROFLUIDIC CHIP AND A MICROFLUIDIC APPARATUS FOR MONITORING A SUBSTANCE IN A MICROFLUIDIC CHIP INCLUDING SUCH SYSTEM

(71) Applicants: TotalEnergies OneTech, COURBEVOIE (FR); CENTRE NATIONAL DE LA RECHERCHE SCIENTIFIQUE - CNRS, Paris (FR); UNIVERSITE DE RENNES, Rennes (FR)

(72) Inventors: Alexis MAURAY, Basse-Goulaine (FR); Patrick CHASLE, Noyal-sur-Vilaine (FR); Jean-Charles POTIER, Brece (FR); Marie-Caroline JULLIEN, Rennes (FR); Ahmad AL FARRA, Le Havre (FR); Bernard MONASSE, Antibes (FR); Enric SANTANACH CARRERAS, Louey (FR)

(73) Assignees: TotalEnergies OneTech, COURBEVOIE (FR); CENTRE NATIONAL DE LA RECHERCHE SCIENTIFIQUE - CNRS, Paris (FR); UNIVERSITE DE RENNES, Rennes (FR)

(21) Appl. No.: 18/268,137

(22) PCT Filed: Dec. 16, 2021
(86) PCT No.: PCT/EP2021/086293

§ 371 Date: Jun. 16, 2023

(30) Foreign Application Priority Data
Dec. 17, 2020 (EP) 20306593.3

(51) Int. Cl. B01L 7/00; B01L 9/00

(52) U.S. Cl. CPC B01L 7/00; B01L 9/527; B01L 2200/146; B01L 2200/147; B01L 2200/148; B01L 2300/023; B01L 2300/1822; B01L 2300/185

(57) ABSTRACT

The invention concerns a system for controlling the temperature of a microfluidic chip comprising a Peltier module (10) having a cold face (10a) and a hot face (10b) and connected to a power generator (11), a thermal regulation device (12) having a thermal regulated face (12a) applied against one of the faces of the Peltier module, at least one temperature sensor (17) being applied on the other face of the Peltier module and being intended to be applied against one of the main faces of a microfluidic chip and control means (18) configured to control the power generator (11) of the Peltier module depending on a temperature of the face of the Peltier module provided with said at least one temperature sensor and at least one temperature setting information selected from a target temperature and a target temporal temperature profile to regulate a temperature of the face of the Peltier module to said temperature setting information.

### TECHNICAL FIELD OF THE INVENTION

The present invention relates to a system for controlling the temperature of a microfluidic chip, to a temperature controlled microfluidic assembly and a microfluidic apparatus for monitoring a substance including such system. This microfluidic apparatus may be used for many applications in chemistry, physic, physical chemistry, biochemistry, biology, such as for monitoring crystallization of a substance, for monitoring interfacial mechanisms, for DNA amplification, thermotaxis, chemotaxis, etc, as long as there is a need for an accurate temperature control, in particular for microscopy or spectroscopy monitoring, and under a static or dynamic flow in a microfluidic chip.

### BACKGROUND

Crystallization of complex mixtures such as complex hydrocarbon fluids is studied in order to determine when a hydrocarbon fluid may crystallize and plug the pipelines in which it is transported. More specifically, below the melting temperature of some compounds contained in these fluids, generally paraffins and/or waxes, crystallization phenomena may lead to the formation of plugs. For such studies, microfluidics is a useful tool as it gives the advantage of visualizing the crystallization in flows or not on a microscopic scale. Such an experiment requires a complete control of the flow, but also of the physical conditions in which the phenomena occur. One of the major technical issues is the control of the temperature of the sample at the time of its injection, in particular at low temperature, inferior to 0° C.

EP2121186B1 discloses a microfluidic device for study of crystallization of chemical species. The device includes a microchannel etched in a sheet, for example made of polydimethylsiloxane (PDMS) and sealed by means of a plate, for example made of silicon so as to increase heat transfer. Means for heating and cooling the droplets stored in the microchannel are associated to this plate. The temperature of the sheet is controlled using a Peltier module and water circulation from a cryostat, both items being placed immediately beneath the plate. Four thermocouples are inserted through the PDMS layer as far as the silicon plate, to take temperature measurements close to the microchannel. This document does not mention the possibility of study at low temperature. It is not clear either where the thermocouples are positioned inside the PDMS layer and if an accurate temperature control may be obtained. Finally, there is no possibility to use an optical microscopy in transmission with the apparatus disclosed. Moreover, the deficiency of a thermocouple requires the replacement of the whole microfluidic device.

US20170001196 describes a portable microfluidic system capable of rapid diagnosis. The system includes a thermoelectric semi-conductor, in particular a copper thermoelectric semi-conductor, to heat or cool one or more microchannel of a microfluidic chip. Different temperature conditions can be applied to different regions of the microfluidic chip. The temperature regulation is however not detailed. A drawing only shows a temperature sensor, a temperature controller linked to the copper thermoelectric semi-conductor and a heat sink below it. The system disclosed does not allow analyzing means working in transmission.

US2020055043 discloses a microfluidic system for the isolation of particles belonging to a sample. A first regulating assembly is provided on a lateral part of the microfluidic device and a second regulating assembly is provided below the central part of the microfluidic device. Both regulating assemblies are cooling systems. The first regulating assembly includes a Peltier cooler placed on a lateral part of an element for cooling a reservoir, the element recovering the microfluidic device. This microfluidic system is not compatible with analysis means working in transmission.

EP3524353 discloses a device for thermocycling biological samples which comprises several heat pumps such as Peltier elements for heating and cooling a mount for receiving the biological samples. The mount can comprise a flat upper size for receiving a microfluidic device. The Peltier elements are in contact with a heat exchanger. Temperature sensors provided at the mount, heat pump and heat exchanger are used to monitor the system. The position of the sensors is not disclosed. This device is not compatible with analysis means working in transmission.

There is therefore a need for a system for controlling the temperature of a microfluidic chip allowing accurate temperature regulation and easier maintenance. There is also a need for a system for controlling temperature that can be used assembled to a microfluidic chip and which allows the use of analyzing means working in transmission or reflection depending on the need, under static or dynamic flow conditions of the substance to analyze.

### SUMMARY OF THE INVENTION

The present invention intends to overcome all or parts of the above drawbacks.

According to a first aspect, the present invention provides a system for controlling the temperature of a microfluidic chip, said microfluidic chip being of the general form of a flat plate having two opposite main faces and in which is embedded at least one microchannel for receiving a substance, said system comprising:
a Peltier module having a cold face and a hot face and connected to a power generator,
a thermal regulation device having a thermal regulated face applied against one of the cold and hot faces of the Peltier module,
at least one temperature sensor positioned on the other face of the cold and hot faces of the Peltier module and being intended to be applied against one of the main faces of the microfluidic chip,
an optional thermal conductive layer made of a thermal conductor material and within which is placed said at least one temperature sensor, said thermal conductive layer being applied on the other face of the cold and hot faces of the Peltier module and being intended to be applied against one of the main faces of the microfluidic chip,
control means configured to control the power generator of the Peltier module depending on a temperature of the thermal regulation device and at least one temperature setting information selected from a target temperature and a temporal temperature profile, and to regulate a temperature of the face of the Peltier module provided with said at least one temperature sensor to said at least one temperature setting information.

Such arrangement allows an accurate control of the temperature of the thermal conductive layer and consequently of any microfluidic chip applied against it. By regulating one of the cold and hot faces of the Peltier module with the thermal regulation device, the system of the invention allows monitoring the temperature of the thermal conductive layer in a wide range of temperatures, for example from −25° C. to 100° C. or even a wider range, by choosing an appropriate temperature of the thermal regulation device, an appropriate Peltier module and an appropriate temperature of the thermal regulation device, typically by choosing an appropriate heat transfer fluid. The thermal regulation device also imparts a good stability of the temperature of the thermal conductive layer measured by the temperature sensor.

According to a second aspect, the present invention provides a temperature controlled microfluidic assembly comprising:
a microfluidic chip of the general form of a flat plate having two opposite main faces and in which is embedded at least one microchannel for receiving a substance,
at least one temperature controlling system according to the invention, the face of the Peltier module thereof provided with said at least one temperature sensor, optionally the face of the thermal conducting plate, being applied against one of the main faces of the microfluidic chip.

Such an assembly allows an accurate monitoring of the temperature inside the microfluidic chip which can be used in any application of such microfluidic chip, in particular an analytic application.

A single temperature controlling system may be provided on one face of the microfluidic chip. It may however be envisaged to provide two temperature controlling systems, the faces of the Peltier module of the systems provided with said at least one temperature sensor being applied on the opposite main faces of the microfluidic chip. In this case, both temperature controlling systems may be controlled with the same temperature setting information, or a single control means may control both temperature control systems. The temperature setting information used to regulate the face of the Peltier module provided with said at least one temperature sensor of each temperature controlling system may be the same for both temperature controlling systems so as to limit the temperature gradient across the thickness of the microfluidic chip, or may be different to apply a thickness-controlled temperature gradient across the microfluidic chip.

According to a third aspect, the present invention provides a microfluidic apparatus for monitoring a substance present in a microfluidic chip of the general form of a flat plate having two opposite main faces and in which is embedded at least one microchannel for receiving the substance, comprising:
at least one temperature controlled system according to the invention, the face of the Peltier module thereof provided with said at least one temperature sensor, optionally the thermal conductive layer thereof, being intended to be applied against one of the main faces of the microfluidic chip,
optionally at least one fluidic circuit intended to be connected to said at least one microchannel of the microfluidic chip and flow controlling means connected to said fluidic circuit for controlling a flow rate or a pressure of the substance within said at least one microchannel, optional means connected to said fluidic circuit for measuring a pressure drop through said at least one microchannel,
means for analyzing the substance within said at least one microchannel of the microfluidic chip,
control means for controlling said at least one temperature controlled system and said analyzing means, and optionally the flow controlling means.

Such microfluidic apparatus allows in particular monitoring of a substance under static or dynamic conditions, with an accurate monitoring of the temperature. Analysis by imaging, optical microscopy, or any other non destructive spectroscopy technic, is also possible, in reflection or in transmission. In the last case (analysis in transmission), the temperature controlling system is provided with a through hole traversing the optional thermal conductive layer, the Peltier module and the thermal regulation device, said hole having an axis perpendicular to the faces in contact of these elements. This through hole is not necessary when the analyzing means work in reflection. Such through hole can however also be used to apply a temperature gradient profile to a microfluidic chip in a plane perpendicular to the axis of the hole, at the location of this hole. The gradient profile can be set by selecting appropriate form and dimensions of the through hole. In particular, the gradient profile may be previously determined by measuring the temperature of the chip at any location of its area corresponding to the hole, for a predefined size and form of the hole. The gradient profile may be flat (homogeneous temperature) or not.

Thus, in an embodiment, the temperature controlling system may be provided with a through hole traversing the optional thermal conductive layer, the Peltier module and the thermal regulation device, said hole having an axis perpendicular to the faces in contact of these elements.

Advantageously, the through hole may have a defined size and form, preferably configured to apply a defined temperature gradient profile in a plane perpendicular to the axis of the hole and through said hole in that plane, in particular within a microfluidic chip the temperature of which is to be controlled by the temperature controlling system of the invention.

According to a fourth aspect, the present invention provides a method for monitoring a substance using the microfluidic apparatus of the invention and a microfluidic chip of the general form of a flat plate having two opposite main faces and in which is embedded at least one microchannel for receiving the substance. The method for monitoring comprises:
placing one main face of the microfluidic chip in contact with the face of the Peltier module of said at least one temperature regulating system provided with said at least one temperature sensor, optionally with the thermal conductive layer of the temperature regulating system,
introducing said substance inside said at least one microchannel before placing the microfluidic chip or after connecting said at least one microchannel of the microfluidic chip to said at least one fluidic circuit,
setting the temperature of the thermal regulating device at a first value,
setting at least one temperature setting information selected from a target temperature and a target temporal temperature profile for the temperature of the face of the Peltier module of said at least one temperature regulating system provided with said at least one temperature sensor,
regulating the temperature of the face of the Peltier module of said at least one temperature regulating system provided with said at least one temperature sensor to said at least one temperature setting information by controlling the power generator of the Peltier module,
monitoring the substance using means for analyzing the substance within said at least one microchannel during the temperature regulation step and optionally under flow rate or pressure control of said substance inside said at least one microchannel.

Such a method allows monitoring of the temperature inside the microchannel in a wide range of temperatures, for example from −25° C. to 100° C. or a wider range, either under static or dynamic conditions of the substance within the microfluidic chip, and under monitoring by the analyzing means. For example, for crystallization monitoring, dynamic conditions allow measuring the size of the crystals formed, for example by analyzing means such as microscopy, and controlling the crystal growth. Under static conditions, evolution of the size of crystals, and in particular of a single crystal, can be monitored, in general also by microscopy. However, many other applications may be envisaged for which analyzing means are used and an accurate temperature control is needed, under dynamic or static flow conditions of the substance.

When the temperature controlling system is provided with a traversing through hole, a size and form of the hole may be advantageously selected to apply a defined temperature gradient profile in a plane perpendicular to the axis of the hole and through this hole in that plane, within the microfluidic chip. In such a case, during the temperature regulating step, the temperature of the surface of the microfluidic chip within the hole follows the defined temperature gradient profile and the monitoring step may include monitoring the substance at different locations of the microfluidic chip within the through hole, the analysis means having a measurement axis aligned with the axis of the hole.

It is then possible to monitor the behavior of a substance as a function of this temperature gradient profile.

### DETAILED DESCRIPTION

The system for controlling the temperature of the invention is designed to be used for a microfluidic chip in which is embedded at least one microchannel for receiving a substance. Such microfluidic chip is of the general form of a flat plate having two opposite main faces. The at least one microchannel extends between these two main faces, which correspond to the greatest faces of the microfluidic chip.

The system of the invention comprises a Peltier module connected to a power generator, a thermal regulation device, at least one temperature sensor, an optional thermal conductive layer and control means.

In a known way, in a Peltier module (also named “Peltier effect thermoelectric module”), a succession of pairs of conductors of different electrical conductivity is provided through which an electric current flows to create a temperature gradient between two faces, generally opposite, of the module. As a consequence, a Peltier module has a cold face and a hot face which can be inverted by inverting the direction of the current flow through the Peltier module. A Peltier module is generally characterized by the temperature difference it can maintain between its cold and hot faces, the cold face having a temperature inferior to the temperature of the hot face. Preferably, the Peltier module will be designed to have a sufficient temperature difference to reach the temperatures required for a particular application. The temperature gradient between the faces of the Peltier module can be modulated by controlling the voltage applied to the Peltier module by the power generator. In the present invention, the hot and cold faces of the Peltier module are preferably opposite faces, in particular parallel to each other.

The thermal regulation device is configured to regulate the temperature of one of the faces of the Peltier module. A heat transfer can then operate between the two elements. Any thermal regulation device having a thermal regulated face may be used to this effect, such as a heat exchanger or any other thermal regulating device such as a cryostat or a heating device, alone or in combination. Regulating the temperature of the hot face of the Peltier module will allow to obtain lower temperatures on the cold face to be applied against the microfluidic chip and will also improve the accuracy of the temperature regulation. Regulating the temperature of the cold face of the Peltier module will allow obtaining higher temperatures on the hot face to be applied against the microfluidic chip. The thermal regulation device also allows obtaining a temperature stability of the face of the Peltier module to be applied against the microchip.

The at least one temperature sensor is positioned on the face of the Peltier module intended to be applied against one of the main faces of the microfluidic chip, in other words on the other face of the cold and hot faces of the Peltier module which is not in contact with the thermal regulation device. The optional thermal conductive layer is made of a thermal conductor material, when present, it includes said at least one temperature sensor. This thermal conductive layer is intended to be applied against one of the main faces of the microfluidic chip. It is also applied against the other face of the Peltier module (i.e. the face of the Peltier module opposite its face in contact with the thermal regulating device). This thermal conductive layer allows positioning a temperature sensor close to the face of the Peltier module to be applied against the main face of a microfluidic chip, the temperature of which is to control, without impeding the heat transfer between the Peltier module and the microfluidic chip.

Finally, the control means are configured to control the Peltier module, more specifically the power generator connected to the Peltier module, depending on a temperature of the thermal regulation device and at least one temperature setting information selected from a target temperature and a target temporal temperature profile, and to regulate a temperature of the face of the Peltier module provided with said at least one temperature sensor to said at least one setting information temperature.

The target temporal temperature profile represents a temperature variation as a function of time. This temporal temperature profile may be of the form of a sinusoid, saw-tooth, crenellations or any other form depending on the requirements.

Said target temperatures and/or target temporal temperature profiles may correspond to one or several temperatures of the defined temperature gradient profile (in a plane perpendicular to the axis of the hole) applied within the traversing through hole when present at different positions within the through hole.

In one embodiment, for a more accurate temperature regulation, the cold face of the Peltier module may be applied against the thermal regulated face of the thermal regulation device.

Advantageously, in the system of the present invention, the faces that are applied against other faces are flat faces, in particular flat parallel faces, to increase thermal exchanges between the faces.

In an embodiment, to improve the heat transfer between the elements of the temperature controlling system, a thermal paste may be applied between the elements in contact, in particular between their faces in contact. Such thermal paste may fix the elements in contact together. In particular, the thermal regulating device and the Peltier module and optionally the thermal conductive layer, may be assembled using a thermal paste, for example a thermal paste reticulating after application. When assembled, they may form a thermal regulated unit. They may for example be assembled to each other using a thermal paste or mechanically or using any other means allowing their assembling.

In an embodiment, for better heat exchanges and compact design, the thermal conductive layer may recover entirely the face of the Peltier module, and optionally has the same form and dimensions as the face of the Peltier module.

Advantageously, the optional thermal conductive layer, the thermal regulation device and the Peltier module may have their faces in contact of the same form and surface for a more compact design and easy manufacturing. The same form and dimensions of the faces in contact can be any predefined form and dimensions chosen depending on the form and dimensions of the monitoring area of the microfluidic chip.

In particular, the form and dimensions of the faces in contact are the same as those of the monitoring area chosen. Advantageously, the overall form and dimensions of the optional thermal conductive layer, the thermal regulation device and the Peltier module in a direction perpendicular to their faces in contact are identical along this direction.

Advantageously, the thermal regulation device may include:
a fluid reservoir for storing a heat transfer fluid,
a thermal regulation element inside which a channel or a chamber is embedded, said channel or chamber being in fluid communication with said fluid reservoir, one face of said thermal regulation element being the thermal regulated face applied against the hot face of the Peltier module,
flow control means for controlling the flow rate of the heat transfer fluid within said channel.

The temperature of the thermal regulated device is then the temperature of the fluid in the fluid reservoir, in particular the temperature of the fluid at an inlet of the fluid in the thermal regulated element. This temperature may be regulated using a thermal regulating means configured to regulate the temperature of the fluid contained in the fluid reservoir. These thermal regulating means may include a heating device, a heat exchanger, a cryostat or any other thermal regulating device, alone or in combination. In case of such temperature regulation of the fluid contained into the fluid reservoir, a temperature sensor may be provided for measuring such temperature and the control means may be configured to control the thermal regulating means to attain a target temperature of the fluid contained in the fluid reservoir. Alternatively, the temperature of the thermal regulated device may not be regulated and may correspond to the room temperature, eventually with some variations due to the temperature of the fluid returning to the reservoir after passing through the thermal regulation element.

When the temperature controlling system is provided with a traversing through hole, the thermal regulation element is also provided with a corresponding traversing through hole, the axis of which is perpendicular to the thermal regulated face.

As explained above and represented in the drawings, the optional thermal conductive layer, the thermal regulation device, in particular its thermal regulation element, and the Peltier module may advantageously be assembled to each other and form a temperature regulated unit. Advantageously, the optional thermal conductive layer, the thermal regulation device, in particular its thermal regulation element, and the Peltier module assembled in a temperature regulated unit may have an overall form and dimensions, in a direction perpendicular to their faces in contact, identical along this direction.

By way of example, the channel or chamber inside the thermal regulation element may have an inlet and an outlet each connected to the fluid reservoir by ducts, the flow control means of the thermal regulation device being provided on a duct or inside the fluid reservoir for circulating the heat transfer fluid through the channel of the thermal regulation element. The inlet and outlet may be provided on walls of the thermal regulation element which extends transversally to its face in contact with the Peltier module, preferably on opposite walls.

The thermal regulation element may be made of any thermal conductive material, preferably from copper or aluminium.

The thermal regulation element may be a block made of a thermal conductive material, i.e. a piece of thermal conductive material inside which is provided a channel or chamber for fluid circulation, for example a single channel or chamber. Such block may be made in two parts for easy manufacturing, the two parts of the block being assembled in a fluid tight manner by any appropriate means, or by assembling in a fluid tight manner more than two parts. The block may also be a single block, for example manufactured by 3D printing.

The thermal conductive layer may be chosen from a plate made of a rigid material and a layer made of a soft material. Preferably, the thermal conductive material chosen does not undergo a phase change in the temperature range in which the temperature controlling system is used.

By rigid material is meant a material that can not be bent or deformed under the sole effect of gravity, in particular in the temperature range in which the temperature controlling system is used. A rigid thermal conductive material may be a metallic material, preferably chosen from aluminium and copper, preferably copper for the thermal conductive layer, although other thermal conductive material may be envisaged such as aluminium alloys or any other thermal conductive metal alloy, or composite materials, for example a solid polymer filled with thermal conductive filler.

By soft material is meant a material that can be bent or deformed under the sole effect of gravity, in particular in the temperature range in which the temperature controlling system is used. A soft thermal conductive material may be chosen from colloids, polymers, liquid crystals, gels, emulsions or foams, filled with thermal conductive filler, such as for example filled silicones.

In a general way, the material chosen has a sufficient thermal conductivity to transfer heat from the Peltier module to a microfluidic chip. An appropriate material can be chosen by monitoring the temperature of a microfluidic chip for example by thermal cameras such as infra red cameras.

In a preferred embodiment, the thermal conductive layer may be a plate made of copper or any other thermal conductive material, in particular metallic, although copper is preferred.

When a soft material is used, the thermal conductive layer may be prepared in advance at the wished forms and dimensions before being applied, in particular assembled, to the Peltier module. It should be noted that in such a case, the temperature sensor may be embedded within the soft material.

To improve accuracy of the temperature control, the thermal conductive layer may have a thickness, measured perpendicularly to the face of the Peltier module against which it is applied, equal or substantially (±10%) equal to a thickness of said at least one temperature sensor. This may avoid application of mechanical constraints on the microfluidic chip.

Advantageously, for a more accurate and stable temperature measurement, the temperature sensor may be a resistance temperature detector. Such detectors are sensing elements that are made of pure platinum, copper or nickel wire coil (wire wound) encapsulated in ceramic or glass, or a thin film platinum, copper or nickel deposited on a ceramic substrate. They are therefore space saving. Preferably, the temperature sensor may be a platinum resistance temperature detector. Such temperature sensor may be a micro sensor. It may be envisaged to deposit directly the metal film on the face of the Peltier module to control.

For easy mounting, when present, the thermal conductive layer may have a traversing hole in which is nested said at least one temperature sensor. Such traversing hole may be a simple notch. The temperature sensor can then be easily mounted on the thermal conductive layer or removed from it.

The temperature control system of the invention may be used to control the temperature of a microfluidic chip, the microchannel(s) of which is(are) monitored by analyzing means, for example imaging means, optical means such as optical microscopy means, or spectroscopy means. In such a case, the optional thermal conductive layer, the Peltier module and the thermal regulation element may each present a traversing hole having a same axis perpendicular to their faces in contact. In other words, the temperature controlling system has a through hole traversing the optional thermal conductive layer, the Peltier module and the thermal regulation device, said hole having an axis perpendicular to the faces in contact of these elements. This may allow to position analyzing means on any side of a microfluidic chip assembled to the temperature controlling system of the invention, a measurement axis of the analyzing means being aligned with the axis of the through hole. This through hole may be centrally positioned and may be of any geometric form although a cylinder is easier to make. Preferably, the size of the through hole is sufficient for the passage of an analysis measurement beam emitted and/or received by the analyzing means. This size may also be selected to apply a defined temperature gradient profile (in a plane perpendicular to the axis of the through hole) as previously explained.

The temperature controlling system of the invention may be used in a temperature controlled microfluidic assembly comprising a microfluidic chip of the general form of a flat plate having two opposite main faces and in which is embedded at least one microchannel for receiving a substance. In such a case, the face of the Peltier module of the temperature controlling system provided with said at least one temperature sensor, or the thermal conducting layer when present, is applied against one of the main faces of the microfluidic chip. Another temperature control system may be provided applied against the other main face of the microfluidic chip.

Advantageously, for good heat exchanges, the face of the Peltier module of the temperature controlling system provided with said at least one temperature sensor, or the thermal conductive layer when present, may recover at least partly a monitoring area of the main face of the microfluidic chip against which it is applied. Such monitoring area corresponds to an area of the microfluidic chip in which the substance is to be analyzed. When analyzing means work in transmission and a through hole is provided in the temperature controlling system(s), the face of the Peltier module, or the thermal conductive layer, then recovers partly the monitoring area. The monitoring area is thus defined by the face of the Peltier module or the face of the thermal conducting layer when present, applied against one of the main faces of the microfluidic chip.

The size of the face of the Peltier module or of the thermal conductive layer applied on the microfluidic chip (and consequently the size of the whole temperature controlling system when its faces in contact have the same size and form, in other words the size of the monitoring area) can be chosen depending on the monitoring required for the microfluidic chip. In other words, this face defines the monitoring area in which the temperature is regulated. If the entry and exit of the microchannel(s) are to be thermally regulated, the temperature controlling system will recover preferably the microchannel(s) and their respective entry and exit: the monitoring area may then recovers a major (more than 50%) part of the main face. If it is not required to thermally regulate the entry and exit of the microchannel(s), the temperature controlling system may recover only the part of the microfluidic chip to monitor by the analyzing means, for example a monitoring area extending between the entry and exit of the microchannel(s). This monitoring area includes the through hole traversing the optional thermal conductive layer, the Peltier module and the thermal regulation device when present. The minimum dimensions of the through hole depend on the analysis beam dimensions chosen. The maximum dimensions may depend from the size of the microfluidic chip. Examples of diameter dimension for the through hole are from 3 mm to 20 mm or from 4 mm to 16 mm.

The temperature controlled system of the invention may be used in any microfluidic apparatus requiring a temperature control of a microfluidic chip. This system is particularly useful in microfluidic apparatus for monitoring a substance present in a microfluidic chip of the general form of a flat plate having two opposite main faces and in which is embedded at least one microchannel for receiving the substance. Such a microfluidic apparatus may comprise:
at least one temperature controlling system according to the invention, the face of the Peltier module thereof provided with said at least one temperature sensor, optionally the thermal conductive layer thereof, being intended to be applied against one of the main faces of the microfluidic chip,
optionally at least one fluidic circuit intended to be connected to said at least one microchannel of the microfluidic chip, in particular to an entry and an outlet of said at least one microchannel, and flow controlling means connected to said fluidic circuit for controlling a flow rate or a pressure of the substance within said at least one microchannel, optional means connected to said fluidic circuit for measuring a pressure drop through said at least one microchannel,
means for analyzing the substance within said at least one microchannel,
control means for controlling said at least one temperature controlling system and analyzing means, and optionally the flow controlling means.

Advantageously, the control means of the microfluidic apparatus may include the control means of the temperature controlling system(s).

The means for analyzing a substance may be chosen among non destructive analyzing means by spectrometry (Raman, Ultra violet, infra red or visible spectrometer) and optical microscopy (optical microscope) operating in transmission or in reflection. Such optical microscope may be provided with a polarizer/analyzer or phase contrast. The analyzing means may include imaging means such as a charge coupled device to convert light signal emitted by the analyzing means into electric signal for further treatment. When the means for analyzing a substance are operating in transmission, said at least one temperature controlling system is provided with a through hole having an axis aligned with an axis measurement of the analyzing means, this axis being perpendicular to its faces in contact. Typically, in transmission or in reflection, the analysis means emit/receive an analysis beam along the axis of measurement.

The optional flow controlling means allow monitoring the substance under static or dynamic conditions inside the microchannel(s), i.e. with the substance flowing or not through this microchannel(s). They comprise connecting means for their fluidic connection to the fluidic circuit. Such flow controlling means are generally also used to introduce the substance to monitor inside the microchannel(s), in particular under dynamic flow analysis. In the case of static measurement, the microchannel of the microfluidic chip may be filled previously to its placing within the apparatus, without the use of the flow controlling means, which may then eventually be omitted.

Such flow controlling means may preferably be configured to be controlled by the microfluidic apparatus control means. These flow controlling means may include at least one element connected to the fluidic circuit chosen from a flow monitor, a flow meter, a pressure monitor and a pressure sensor.

A flow monitor may be a volumetric pump or a syringe pump. Such flow monitor is connected to the fluidic circuit on an inlet side of said at least one microchannel. The pressure monitor may be a pressure vessel connected to the fluidic circuit on an inlet side of said at least one microchannel.

The flow rate or the pressure inside the microchannel(s) may be controlled by the control means of the apparatus.

By way of example, the flow controlling means may be configured to impose a flow rate, typically by means of a flow monitor placed upstream of the microfluidic chip, either to measure the corresponding pressure drop or to obtain a target pressure measured via one or several pressure sensors placed upstream and/or downstream of the microfluidic chip. Downstream and upstream are to be considered with respect to the circulation of the substance in the fluidic circuit and microfluidic chip.

Alternatively, the flow controlling means may be configured to impose a pressure, typically by means of a pressure monitor placed upstream of the microfluidic chip, either to measure the corresponding flow rate or to obtain a target flow rate measured via at least one flow meter, placed upstream and/or downstream of the microfluidic chip. Preferably, the flow meter may be connected to the fluidic circuit on an outlet side of said at least one microchannel. Such a position may allow detecting a leak or a plug inside the microchannel and improving the accuracy of measurement of the flow. The flow meter may preferably be positioned as close as possible to the microchannel outlet to detect any leak and plug accurately.

The monitoring of a substance using the microfluidic apparatus of the invention is now described. One of the main faces of the microfluidic chip is first placed in contact with the face of the Peltier module of said at least one temperature regulating system provided with said at least one temperature sensor or with the thermal conductive layer when present. A thermal conductive paste may be used to assemble the chip to the system. Advantageously, the Peltier module may be assembled to the optional thermal conductive layer, the thermal regulation device, in particular its thermal regulation element, to form a temperature regulated unit. In such a case the temperature regulated unit is assembled to the chip.

The substance to study is introduced inside said at least one microchannel of the microfluidic chip either before placing the microfluidic chip in contact with the temperature controlling system, or after connecting said at least one microchannel of the microfluidic chip to said at least one fluidic circuit when present. This introduction may be performed by means of the flow controlling means when present, after connection of the microchannel(s) to the fluidic circuit(s). Such introduction may be performed under constant pressure or under constant flow rate for measurement in dynamic conditions. Of course, instead of constant pressure/flow rate, varying pressure/flow rates may be applied by the control means. Alternatively, the microchannel may be filled with the substance and the pressure and flow rate may be set to zero to perform analysis under static conditions. In another alternative, in the absence or presence of flow controlling means and fluidic circuit, the microchannel(s) may be filled with the substance before being placed into contact with the temperature regulating system(s): the microchannel may in particular be sealed without being connected to a fluidic circuit.

The temperature of the thermal regulating device, for example the temperature of the heat transfer fluid contained in the fluid reservoir, is set at a first value. This setting can be performed before or after introduction of the substance inside the microchannel. The man skilled in the art will choose this first value depending on the temperature setting information to attain and the temperature gradient of the Peltier module. He may also choose this first value depending on a defined temperature gradient profile (in a plane perpendicular to the axis of the through hole) through the traversing hole when present.

Afterwards, the Peltier module is controlled via its power generator so as to regulate the temperature of the face of the Peltier module of said at least one temperature regulating system provided with said at least one temperature sensor to said temperature setting information. The temperature setting information is typically selected from a target temperature and a target temporal temperature profile. This regulation may impose one or more phases chosen from a heating phase, a stationary phase and a cooling phase to regulate the temperature of the face of the Peltier module of said at least one temperature regulating system provided with said at least one temperature sensor, typically from an initial temperature to a target temperature value and then to a final temperature, these initial and final temperatures being generally different from the target temperature value. More than one target value may be chosen if required. Alternatively or in combination, the regulation may impose a target temporal temperature profile.

When the temperature controlling system is provided with a through hole traversing the optional thermal conductive layer, the Peltier module and the thermal regulation device, in particular its thermal regulation element, the dimensions of the hole may be selected so as to apply a defined temperature gradient profile (in a plane perpendicular to the axis of this through hole) in an area of the chip corresponding to the hole. The temperature gradient profile may have been previously determined by experiments using thermal measuring means, such as a thermal camera. This defined temperature gradient profile may be flat (homogeneous temperature through the hole) or not.

The monitoring of the substance is then performed using means for analyzing the substance within said at least one microchannel. This monitoring is performed during the temperature regulating step and optionally under flow rate control and/or pressure control of said substance inside said at least one microchannel to perform analysis under static or dynamic conditions. The analyzing means may be as disclosed above. The flow control may be realized by the flow controlling means of the microfluidic apparatus.

To avoid condensation of water on the main faces of the microfluidic chip, in particular at low temperature analysis, a flow of dry cold gas (for example N 2) may be circulated around the microfluidic chip during temperature regulation. Alternatively, the main faces of the microfluidic chip may be surface treated with antifogging treatment.

The monitoring may preferably be performed after a calibration of the apparatus. Thus, the method for monitoring a substance may include at least one initial calibrating step. This initial calibrating step may be a flow calibrating step for calibrating the flow controlling means, in particular a flow meter. Alternatively or in combination, this calibrating step may also be a temperature calibrating step for calibrating the temperature controlling system of the invention.

Such step for calibrating the temperature controlling system may comprise:
setting the temperature of the thermal regulating device, for example of the heat transfer fluid contained in the fluid reservoir, at a first value,
introducing a reference substance having a known melting temperature within said at least one microchannel, optionally before setting the temperature of the thermal regulating device,
regulating the temperature of the face of the Peltier module provided with said at least one temperature sensor from an initial temperature to a second temperature below said melting temperature to crystallize the reference substance inside said at least one microchannel by controlling the power generator of the Peltier module,
then regulating the temperature of the face of the Peltier module provided with said at least one temperature sensor from the second temperature to a third temperature above said melting temperature by controlling the power generator of the Peltier module and, during this regulation, using analyzing means for analyzing the substance within said at least one microchannel to detect the melting of the first crystals and registering the corresponding melting value measured by the sensor temperature,
determining a correction correlation to set the sensor temperature value to the melting temperature value of the reference substance.

In particular, when the analyzing means are optical means with a polarizer/analyzer including imaging means, in particular imaging microscopy means, when the first crystals disappear (melt), the intensity of the signal emitted by the analyzing means decreases. The sensor temperature can be registered when such intensity decrease is observed. Several measures of the sensor temperature can be registered by repeating the regulating steps for different heating and cooling speeds.

Thus, the correction correlation may be determined from several tests using different temperature variation rates and/or different reference substances. By way of example, for monitoring crystallization in hydrocarbon fluids, the reference substance may be hexadecane or dodecane. This correction correlation may take into account a thermal diffusion between the Peltier module and the microfluidic chip, for example by measuring the temperature gradient between the face of the Peltier module and the temperature measured by the temperature sensor.

The correction correlation may be registered to be used by the control means, for example in a memory included or connected to the control means. This correction correlation may be constructed by using two reference substances.

It should be noted that it may have been envisaged to perform a temperature controlling system without the temperature sensor. In such a case, a temperature sensor is to be provided on the face of the Peltier module in contact with the thermal regulating device. A temperature control can then be performed with an appropriate calibration of the Peltier module allowing knowing the temperature of the face of the Peltier module in direct contact with the microfluidic chip. However, a Peltier module is usually not stable in time. In other words, the temperature gradient of the Peltier module is varying with time such that a calibration does not allow an accurate temperature regulation after a long time of use.

### DESCRIPTION OF THE DRAWINGS

The invention is illustrated by help of an example showing a possible embodiment of the invention.

FIG. 1 represents schematically an exploded view of a temperature controlling system according to an embodiment.

FIG. 2 represents a perspective view of an example of thermal regulating element.

FIG. 3 represents schematically a part of a microfluidic apparatus including a temperature controlled microfluidic assembly.

FIG. 4 represents schematically in perspective a microfluidic chip.

FIG. 5 represents the temperature variation of the temperature sensor as a function of time measured in example 2.

FIG. 6 represents the temperature variation of the temperature sensor as a function of time measured in example 3.

FIG. 7-9 represent the temperature variations of the surface of a microfluidic chip controlled as disclosed in Example 4 using Peltier module No 1, No 2 and No 3 respectively.

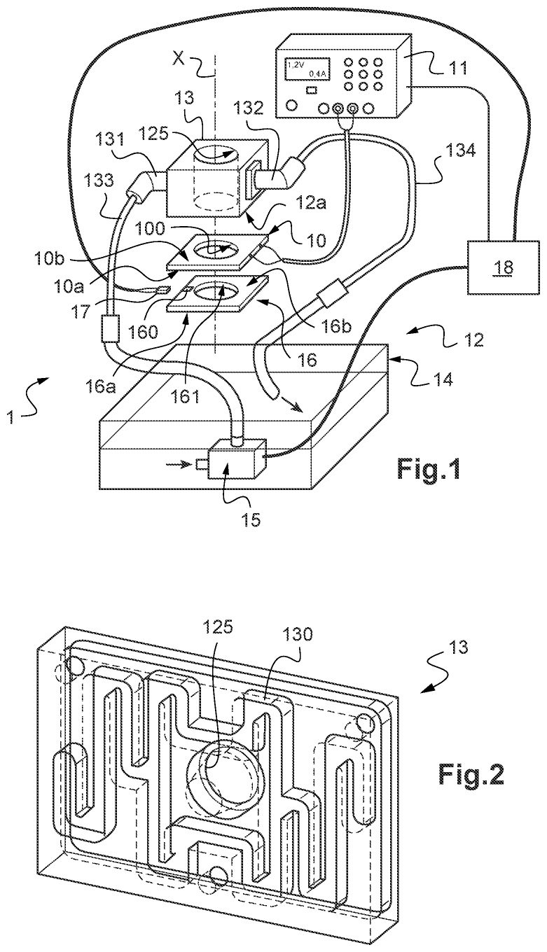

FIG. 1 represents a temperature controlling system 1 comprising a Peltier module 10, a thermal regulation device 12, a thermal conductive plate 16 and control means 18.

The Peltier module 10 is electrically connected to a power generator 11, for example a voltage generator. This Peltier module 10 has a cold face 10a and a hot face 10b, here parallel opposite faces.

The thermal regulation device 12 has a thermal regulated face 12a applied against the hot face 10b of the Peltier module. It should be noted that cold and hot faces may be inversed by inversing the current flow circulating into the Peltier module.

In the embodiment represented, the thermal regulation device 12 comprises a thermal regulation element 13, a fluid reservoir 14 and flow control means 15.

The thermal regulation element 13 is here a block of aluminium having a general parallelepiped form. The invention is however not limited by a particular material or form, provided the material of the element is a heat conductive material. Inside the thermal regulation element 13, is provided a channel 130 (represented FIG. 2) embedded in the block of heat conductive material. Alternatively, the thermal regulation element may define an internal chamber/channel. An entry 131 and an outlet 132 allow the fluidic connection of the channel 130 to the fluid reservoir 14 by ducts 133, 134. Flow control means 15, here a pump immerged in the fluid reservoir 14, circulates the fluid from the fluid reservoir 14 to the channel 130 of the thermal regulating element 13 and back to the fluid reservoir 14, as shown by the arrows in FIG. 1.

The thermal regulated face 12a of the thermal regulation 12 is part of the thermal regulation element 13.

In the embodiment represented, the thermal conductive layer is a plate 16 made of a thermal conductor material, here copper, and includes a temperature sensor 17, here a resistance temperature detector (RTD). Examples of resistance temperature detector that can be used include platinum RTD having a resistance at 0° C. from 100 to 1000 Ohms. The thermal conductive plate 16 has a first face 16a intended to be applied against one of the main faces of a microfluidic chip and an opposite second face 16b applied against the cold face 10a of the Peltier module 10. The first and second faces 16a, 16b of the thermal conductive plate 16 are parallel to each other. These faces correspond to the main faces (the faces with the greatest surfaces) of the thermal conductive plate 16.

In the present description, it should be noted the term “plate” usually designates an element having several faces including two opposite main faces of greatest surface, generally parallel flat faces, this element having a thickness (measured perpendicularly to the main faces) which is much less than the other dimensions of the element.

As shown on FIG. 1, the thermal conductive plate 16 has a traversing hole 160, here a notch, in which is nested the temperature sensor 17.

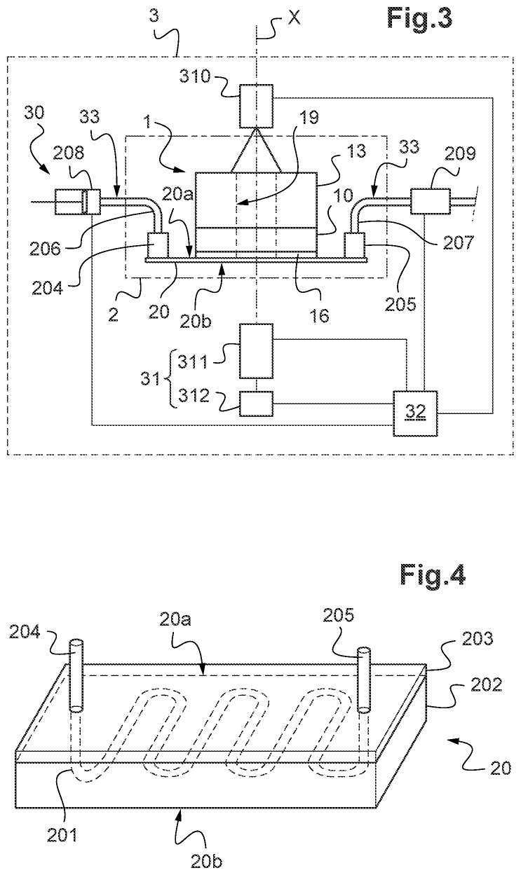

The Peltier module 10, the thermal regulating device 12 and the thermal conductive plate 16 are assembled using a thermal paste. It should be noted that, in addition or alternatively, mechanical binding between these elements may be provided, such as push-fit connections, interlocking or nesting connections, male-female connections, clamping elements. As more clearly shown on FIGS. 1 and 3, the Peltier module 10, the thermal regulation element 13 and the thermal conductive plate 16 are assembled and form a thermal regulated unit.

In the embodiment represented, first and second faces 16a, 16b of the thermal conductive plate 16 and the cold face 10a of the Peltier module have the same dimensions and form, as represented on FIGS. 1 and 3. It can also be seen that the thermal regulated face 12a of the thermal regulation element 13 has the same dimensions and form as the hot face 10b of the Peltier module. Thus, in the embodiment represented, the overall form and dimensions of the thermal regulated unit in the direction perpendicular to the faces in contact are identical along this direction.

In this example, the Peltier module 10, the thermal regulating device 12 and the thermal conductive plate 16 each present a corresponding through hole respectively referenced 100, 125, 161 having a same axis X. In the example represented, the through hole 125 of the thermal regulating device is part of the thermal regulating element 12. Thus, when these elements are superposed, in particular assembled, the holes coincide, as shown in FIG. 3, and form a single through hole 19 of the temperature controlling system 1 traversing the thermal conductive plate 16, the Peltier module 10 and the thermal regulation element 13, this hole 19 having an axis X perpendicular to the faces in contact of these elements. Such configuration will allow observation of the microfluidic chip through this hole, for example by imaging, microscopy or any other analyzing means having a measurement axis which is aligned with the axis of the holes. This hole also allows applying a defined temperature gradient profile (in a plane perpendicular to the axis of said through hole) as explained above and below (see examples).

To improve the thermal contact between the faces applied against each other, a layer of thermal paste (not represented on the figures for clarity sake) is preferably applied between the faces in contact of the elements of the temperature controlling system 1.

The control means 18 are configured to control the Peltier module 10 depending on a temperature of the thermal regulating device 12 (corresponding here to a temperature of the heat transfer fluid in the fluid reservoir) and one or several target temperatures and/or target temporal temperature profiles, and to regulate a temperature of the conductive thermal layer 16 measured by the temperature sensor 17 to said target temperature(s) and/or target temporal temperature profile(s) as previously described. The target temperatures and/or target temporal temperature profiles may correspond to one or several temperatures and/or temperature gradient profiles to apply at different positions within the through hole 19 (in a plane perpendicular to the axis of the through hole), in particular as a function of the size and form of the hole.

These control means 18 may be one or several processors, for example microprocessors or microcontrollers. The processor(s) may have storage means which may be random access memory (RAM), Electrically-Erasable Programmable Read-Only Memory (EEPROM), flash memory, external memory, or other. These storage devices can store, among other things, data received from the temperature sensor, data received from the flow controlling means, temperature correction correlations, defined temperature gradient profiles (in a plane perpendicular to the axis of the through hole) for different sizes and forms of through hole, and computer program(s). The control means 18 may be connected to the temperature sensor 17, the power generator 11 and optionally with the flow control means 15, and thus may include communication means which may be input, output or input/output interfaces. They can be wireless communication interfaces (Bluetooth, WIFI or other) or connectors (network port, USB port, serial port, Firewire® port, SCSI port or other).

The thermal regulation element 13, the thermal conductive plate 16 and the Peltier module 10 are shown assembled to each other on FIG. 3. On this figure, the fluid reservoir 13, the power generator 11 and the temperature sensor 17 are not represented for clarity sake.

This FIG. 3 represents a temperature controlled microfluidic assembly 2 comprising a microfluidic chip 20.

A typical microfluidic chip is represented on FIG. 4. Such microfluidic chip 20 comprises at least one microchannel 201 for receiving a substance. This microchannel 201 is embedded into the material of the microfluidic chip. The microchannel is for example etched on a wafer 202 in a manner known per se. For example, the constituent materials of this wafer are chosen from glass, which is a preferred material, or elastomeric materials such as silicones. Wafers made of PDMS (Poly-(dimethylsiloxane)), silicon, PMMA (Polymethyl Methacrylate), or photosensitive resins such as thiol-ene based resin can also be used. The microchannel 201 can be of any suitable shape, e.g. rectangular cross section. A cross-sectional dimension of the microchannel, usually from about 10 μm to about 100 μm, can be chosen by the man skilled in the art depending on the application.

The individual microchannels 201 are sealed with a plate 203 in a manner known per se. This plate 203 is for example made of silicon or glass.

As shown in FIGS. 3 and 4 the microchannel 201 has an inlet 204 and an outlet 205. The inlet 204 and outlet 205 are suitable for receiving one end of a tube 206, 207 respectively (FIG. 3). The other end of the tube 206 is connected to a syringe pump 208 while the other end of the tube 207 is connected to a flow meter 209. These tubes, syringes and flow meters are well known to the state of the art, so they will not be described in more detail in what follows. The tubes 206, 207 form a fluidic circuit 33.

For a use in an apparatus using an optical, spectroscopy or imaging analyzing means, the material chosen for the wafer 202 or the plate 203 (in case for example of analyzing means working in reflection) or for both the wafer 202 and the plate 203 (in case for example of analyzing means working in transmission) is light transparent (i.e. it lets the light passing through).

The microfluidic chip 20 is thus of the form of a flat plate having two opposite main faces 20a, 20b and in which is embedded said at least one microchannel 201 for receiving a substance.

Usually, microfluidic chips thus have the general form of a flat plate having a thickness (measured perpendicularly to the greater faces) below 1.5 mm, preferably below 1.3 mm, most preferably below 1.1 mm, generally above 500 μm or within any of these limits. The invention is however not limited by a particular thickness of the microfluidic chip, nor by a particular dimension, form and number of microchannel(s).

In the assembly 2 represented FIG. 3, the surface of the thermal conducting plate 16 is inferior to the surface of the microfluidic chip 20 so as to recover a monitoring area of the microfluidic chip between the inlet/outlet of the microfluidic chip 20. The temperature control system is therefore very compact and presents a small size. Alternatively, a thermal conductive plate 16 may recover the whole microfluidic chip 20, including the entry/exit of the microfluidic chip. In such a case, the thermal conductive plate is applied against the face of the microfluidic chip opposite its entry/inlet.

By way of example, the dimensions of face 10b of the Peltier module, in a plane perpendicular to axis X, can be of 15×15 mm with a central through hole of 6-7 mm diameter, the dimensions of the thermal conductive plate 16 and of the thermal regulating element 13 (in a plane perpendicular to axis X) are the same. The thickness of the Peltier module (measured along the axis X) may be of 3-4 mm. The thickness of the thermal conductive plate 16 is of 1 mm, with a notch of 3×3 mm for receiving the temperature sensor 17, the thickness of which is 1 mm. The thickness of the microfluidic chip is about 1.2 mm. The dimensions of the Peltier module, the thermal conductive layer and the thermal regulating element can be adapted to the size of a microfluidic chip and made very compact.

The temperature controlled microfluidic assembly 2 represented FIG. 3 is used in a microfluidic apparatus 3 for monitoring the crystallization of a substance. This apparatus 3 comprises, in addition to the temperature controlling system 1:
a fluidic circuit 33 connected to the entry 204 and outlet 205 of the microchannel 201,
flow controlling means 30 connected to the fluidic circuit 33 for controlling a flow rate of the substance within the microchannel 201,
means 31 for analyzing the substance within said at least one microchannel,
control means 32 for controlling the temperature controlling system 1 and analyzing means, and optionally the flow controlling means.

In general, the apparatus 3 includes an element for supporting a microfluidic chip for example by opposite extremities thereof, not represented here. The temperature controlling system 1 may be placed on a microfluidic chip in a horizontal position. On the other hand, the temperature controlling system 1 may be positioned below a microfluidic chip in a horizontal position and may support this chip. The invention is not limited to a particular orientation of the microfluidic chip and the temperature controlling system, providing both are in contact during analyzing.

The means 30 for controlling a flow rate of the substance include the above mentioned syringe pump 208 and flow meter 209. The syringe pump may be replaced by a pressure reservoir or any other similar device. This means 30 have connecting means for fluidic connection to the fluidic circuit 33 and are typically used to introduce the substance inside the microchannel(s).

The control means 32 may be one or several processors, for example microprocessors or microcontrollers. The processor(s) may have storage means which may be random access memory (RAM), Electrically-Erasable Programmable Read-Only Memory (EEPROM), flash memory, external memory, or other. These storage devices can store, among other things, data received from the temperature sensor, data received from the flow controlling means, temperature correction correlations, and computer program(s).

The control means 32 may include or not the above mentioned control means 18. The control means 32 may be connected to the flow control means 30, to the analyzing means 31 and to the temperature controlling system 1, in particular to its control means 18, or may be itself connected to the temperature sensor 17, the power generator 11 and optionally with the flow control means 15. The control means 32 may thus include communication means which may be input, output or input/output interfaces. They can be wireless communication interfaces (Bluetooth, WIFI or other) or connectors (network port, USB port, serial port, Firewire® port, SCSI port or other).

In the example represented, the analyzing means 31 include a light emitting device 310 on one side of the temperature controlled microfluidic assembly 2 and on the other side, a microscope 311 and a charged couple device 312. This apparatus thus operates in transmission. In a reflection mode, the light emitting device 310 is placed on the same side of the assembly 2 than the microscope 311. In such a case, the temperature controlling device may be provided without the hole 19. Alternatively, the analyzing means may include a spectrometer as explained above or only imaging means.

In a general way, the analyzing means 31 are placed in front of one side of the microfluidic chip or on in front of the two main faces thereof.

The invention is however not limited to the embodiments described, in particular the thermal conductive layer may be omitted.

In particular, the temperature controlling system of the invention allows homogeneous control of the temperature of microenvironments and is thus in particular adapted for imaging by upright or inverted microscopy and for spectroscopy analysis, by reflection or transmission. The controlling system of the invention also allows applying defined temperature gradient profile (in a plane perpendicular to the axis of the through hole) within a specific area of a microfluidic chip corresponding to the location of the traversing through hole when present, allowing monitoring of a substance under different temperature conditions.

The temperature controlling system is suitable for reflection imaging/spectroscopy with homogeneous temperature control over the entire surface of the area of the microfluidic chip in contact with the Peltier module and/or with temperature gradient profile (in a plane perpendicular to the axis of the through hole) control within said specific area of the microfluidic chip. In addition, the temperature controlling system can be adapted for transmission imaging/spectroscopy by providing a perforation though the whole system. In this case, the thermal gradients on the surface of the control area may be an issue, however, thermal camera images show that the thermal gradient is dissipated by contact with a glass slide, the one part of the microfluidic chip because the heat is diffused evenly over the entire surface.

It should also be noted that there is no limit to the surface of the face of the temperature controlling system in contact with the microfluidic chip.

Finally, by setting the temperature of the thermal regulating device at 20° C., the temperature may be controlled homogeneously in a range of 20° C. to −25° C. by choosing an appropriate Peltier module. To widen the temperature ranges, it is possible to increase the temperature of the thermal regulating device to explore temperatures above 20° C. or, on the contrary, to decrease the temperature of the thermal regulating device to go down to temperatures well below −25° C., for example by using liquid nitrogen as heat transfer fluid in the thermal regulating device.

The temperature controlling system of the present invention and the corresponding microfluidic assembly can be used in any application requiring temperature control in microscopy/spectroscopy for questions in physics, chemistry, biology, biotechnology, etc. In particular, the temperature controlling system can be used as well for uses where heating is required, such as biology, biotechnology, and for uses where heating and/or cooling is required, such as in physics, chemistry, physical chemistry.

Moreover, the microfluidic apparatus of the invention can be used in a wide range of applications, in particular when provided with the flow controlling means: static (with or without connection of the microfluidic chip to the fluidic circuit) or dynamic analysis of a substance may be performed using analyzing means working in transmission or reflection. The apparatus may contain one or two temperature control systems, each provided with a through hole thus allowing use of the apparatus with analyzing means working in transmission or in reflection. Alternatively, different temperature controlling system(s) (with or without through holes and/or of different form/dimensions) may be used in the apparatus and changed depending on the analyzing means used (working in transmission or reflection).

### EXAMPLES

Two spatial thermal gradients (i.e. spatial temperature gradients) have been studied in the below examples. The first one is a temperature gradient in the plane of the main faces of the microfluidic chip (in a plane perpendicular to the axis of the through hole), which is adjustable as a function of the dimensions of the through hole (see examples 1 and 4). The second one is a temperature gradient in a direction perpendicular to the main faces of the microfluidic chip (i.e. through the thickness of the microfluidic chip), the effect of which is negligible, all the more so as the height of a microfluidic canal is low.

### Example 1—Temperature Homogeneity in a Plane Perpendicular to the Main Faces of the Microfluidic Chip

Tests have been performed to check the homogeneity of the temperature at the surface of the microfluidic chip using an assembly as described in reference to FIGS. 1 and 3. The features of the elements used are gathered in table 1.

TABLE 1

| | Size (in a plane | Central | | |
|---|---|---|---|---|
| | parallel to the faces | hole | | |
| | in contact) | (diameter) | | Other features |
| Peltier module | 15.1 × 15.1 × 3.18 mm | 6.7 | mm | Voltage range : 0-3.2 V |
| | | | | Current intensity : 0-4 A |
| | | | | Power : 6.9 W |
| Thermal regulating | 15 × 15 × 10 mm | 6.7 | mm | Material : Aluminium |
| element | | | | Heat transport fluid : water |
| Thermal conductive | 15.1 × 15.1 × 1 mm | 6.7 | mm | Material : copper |
| plate | | | | Notch size : 3 × 3 mm |
| Temperature sensor | 3 × 3 × 1 mm | | | Platinum RTD with a resistance of 100 |
| | | | | Ohms at 0° C. |
| Microfluidic chip | 76 × 26 × 1.2 mm | | | Glass chip in which is embedded a |
| | | | | microchannel made of NOA 81 ® |
| | | | | Microchannel height : 100 μm |

In the thermal regulating element, the water at 17-20° C. is circulated with a flow rate of 220 L/h.

A thermal camera, here an infra red camera, is used to measure the temperature at the surface of the Peltier module on its cold side face while the voltage of the Peltier module is varied from 0 to 3.2V. The images of the thermal camera show a temperature gradient at the surface of the Peltier module, due in parts to the central hole.

The same thermal camera is then used to measure the temperature at the surface of the face of the microfluidic chip opposite to the face applied against the thermal conductive plate. The images of the thermal camera show no thermal gradient due to the central hole and homogenization of the temperature on the surface of the microfluidic chip. In other words, there is no spatial temperature gradient in the plane of the microfluidic chip which behaves as a thermal diffusor as well as through the thickness of the microfluidic chip, in particular in the area in contact with the Peltier module (i.e. with the thermal conductive layer).

### Example 2—Temperature Gradient in a Direction Perpendicular to the Main Faces of the Microfluidic Chip

Tests have been performed on the assembly described in example 1 to evaluate the gradient of temperature between the cold face of the Peltier module (face 10a of FIG. 1, as measured by the temperature sensor) and the main face of the microfluidic chip opposite to the temperature controlling system (face 20b of FIGS. 3 and 4), this temperature being measured by a thermal (infra red) camera.

In the thermal regulating element, the water at 17-20° C. is circulated with a flow rate of 220 L/h.

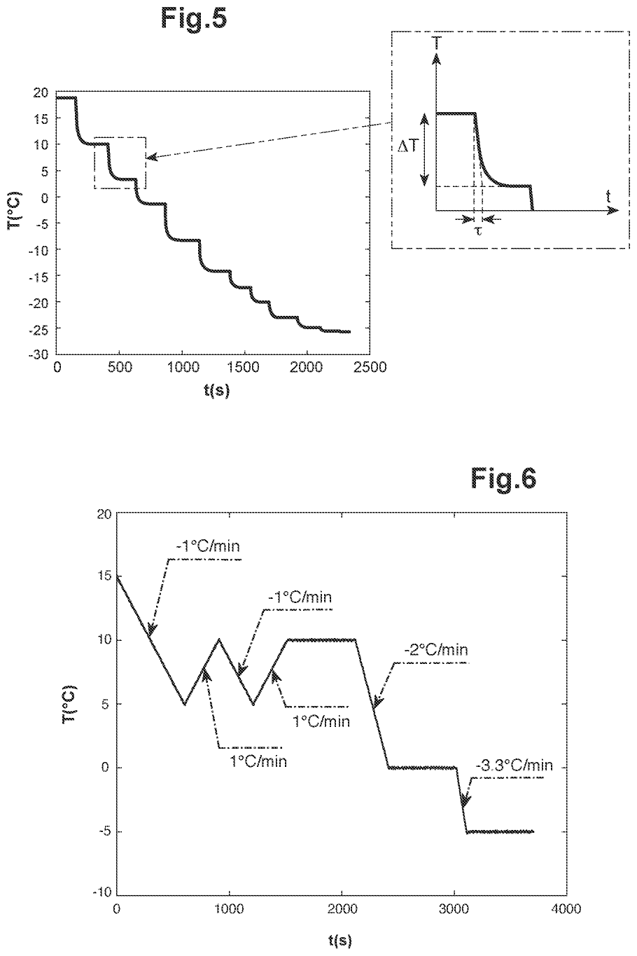

The temperatures have been measured in real time at different voltages. FIG. 5 shows the temperature measured by the temperature sensor as a function of time, and, for each temperature plateau, the transition time t corresponding to a temperature variation ΔT.

Transition time between two plateaus is about 20 s at the surface of the Peltier module (face 10a) and about 60 s at the surface of the microfluidic chip (face 20a). The temporal temperature gradient at the surface of the Peltier module is about 2° C./min, and about 4.8° C./min at the surface of the face 20a of the microfluidic chip.

The minimal temperature attained at the surface of the Peltier module was of −26° C. while the minimal temperature attained at the surface of the face 20a of the microfluidic chip was −18° C. A temperature difference from 1 to 8° C. has been observed between these surfaces, the greatest difference being observed at this minimal temperature.

From these measurements, the spatial gradient through the thickness of the microfluidic chip has been calculated and a value of at most 0.007° C./μm obtained.

For a microchannel of 40 μm of height (or diameter), this results in a temperature gradient of 0.03° C. between the opposite sides of this microchannel and for a microchannel of 100 μm of height (or diameter), this results in a temperature gradient of 0.7° C.

It has also been observed that the heat transfer time through a thickness of 1 mm of glass, the value is 2 to 3 s.

Spatial gradient through the thickness of the microfluidic chip has been estimated (per 100 μm) at 0.02° C. for a minimum voltage applied to the Peltier module and at 0.65° C. for a maximal voltage applied to the Peltier module. It is however expected that the real spatial gradient are below these values as the above estimate does not take into account the thermal exchange between the temperature sensor and the environment.

The above tests show that the temperature controlling system of the invention allows a good temporal control of the temperature plateaus and temperature ramp speed.

### Example 3

FIG. 6 represents the temperature variation measured by the temperature sensor in response to a temperature setting information, here a temporal temperature profile, which is identical to the graph of FIG. 6, without the slight variations observed during the temperature plateaus. This shows that the temperature can be controlled in a very accurate manner.

### Example 4—Temperature Gradient in a Plane Perpendicular to the Axis of the Through Hole as a Function of the Size of the Through Hole

Tests have been performed to measure a gradient of temperature at the surface of the microfluidic chip using an assembly as described in reference to FIGS. 1 and 3 using different Peltier modules having circular central holes of different diameters. The features of the different Peltier modules are gathered in table 2.

Each Peltier module has been assembled to a thermal regulating element made in aluminium and having the same form and dimensions as the Peltier module in a plane parallel to the faces in contact and a thickness of 10 mm. The heat transport fluid used was water. In this example, no thermal conductive plate has been used, nor temperature sensor. The temperature measurements have been performed by an IR camera on a glass plate having a of thickness 1 mm attached to the Peltier module by thermic past on a side opposite to the side attached to the thermal regulating element.

TABLE 2

| | Form and Size - in a | | | |
|---|---|---|---|---|
| | plane parallel to the | | | |
| | faces in contact | Central hole | | |
| | Thickness | (diameter) | | Other features |
| Peltier module No 1 | Square of 15.1 mm × | 6.7 | mm | Voltage range : 0-3.2 V |
| | 15.1 mm | | | Current intensity : 0-4 A |
| | 3.18 mm | | | Power : 6.9 W |
| Peltier module No 2 | Square of 18 mm × 18 | 8 | mm | Voltage range : 0-3.2 V |
| | mm | | | Current intensity : 0-3 A |
| | 3.18 mm | | | Power : 5.2 W |
| Peltier module No 3 | Circle of 26 mm of | 14 | mm | Voltage range : 0-2 V |
| | diameter | | | Current intensity : 0-6 A |
| | 3.18 mm | | | Power : 6.3 W |

In the thermal regulating element, the water at 17-20° C. is circulated with a flow rate of 220 L/h.

A thermal camera, here an infra red camera, have been used to measure the temperature at the surface of the face of the microfluidic chip opposite to the face applied against the thermal conductive plate, within the central hole and through it.

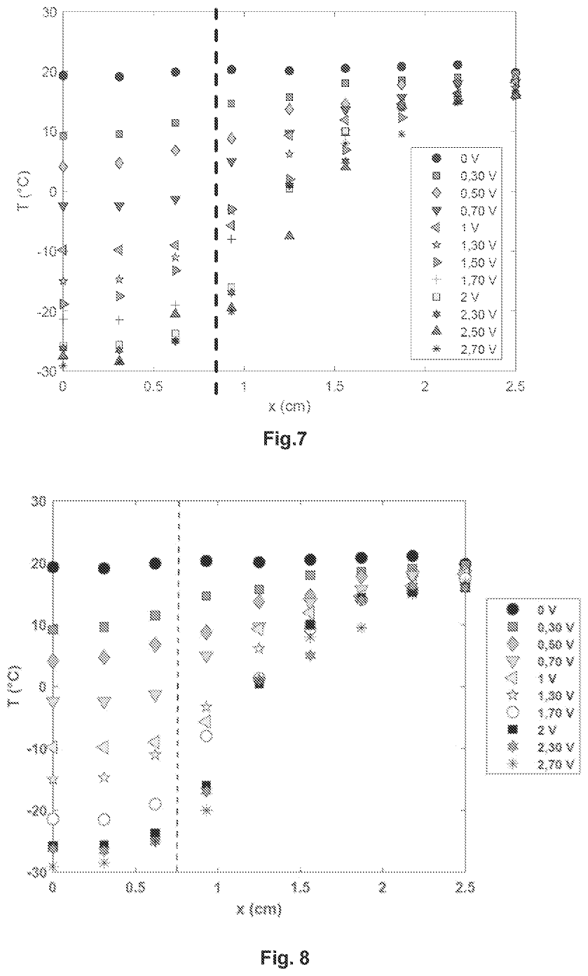

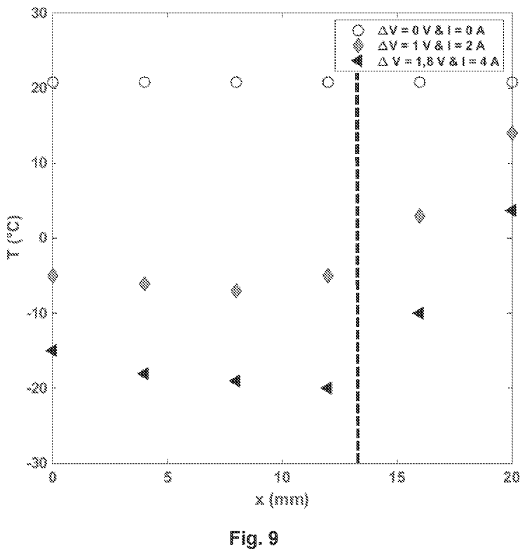

The results are shown on FIGS. 7 to 9, which each represent graphs of the temperature of the surface of the microfluidic chip measured as a function of the distance from the axis (center) of the central hole. The vertical dashed line on each graph represents the edge of the Peltier module. The voltage applied to the Peltier module is specified on the figures for each test. Thus, the test with no voltage applied correspond to a blank test (the temperature corresponded to the room temperature)

We can observe that using the Peltier module No 1, the temperature of the microfluidic chip is homogeneous within the trough hole in the temperature regulation range of −30 to 20° C. (FIG. 7). Outside of the through hole, a temperature gradient is observed at the surface of the microfluidic chip, its temperature increasing as the distance from the edge of the through hole increases. This temperature gradient is largest at the lower temperatures (below −10° C.).

The temperature of the microfluidic chip is also homogeneous within the trough hole when using the Peltier module No 2, in the temperature regulation range of −30 to 20° C. (FIG. 8). Outside of the through hole, a temperature gradient is also observed for temperatures below 0° C.

The temperature of the microfluidic chip is homogeneous within and outside the trough hole when using the Peltier module No 2 for a regulation at 20° C. For a regulation at temperatures below 0° C., we can observe a decrease of the temperature of the microfluidic chip from the axis of the through hole.

These results show that by selecting the size of the through hole, the temperature of the area of the microfluidic chip monitored by the analyzing means can be set and regulated with accuracy allowing applying a constant temperature or a specific temperature profile within the area of the microfluidic chip corresponding to the through hole.

1. System for controlling the temperature of a microfluidic chip, said microfluidic chip being of the general form of a flat plate having two opposite main faces and in which is embedded at least one microchannel for receiving a substance, said system comprising:
a Peltier module having a cold face and a hot face and connected to a power generator,
a thermal regulation device having a thermal regulated face applied against one of the cold and hot faces of the Peltier module,
at least one temperature sensor positioned on the other face of the cold and hot faces of the Peltier module and being intended to be applied against one of the main faces of the microfluidic chip,
an optional thermal conductive layer made of a thermal conductor material and within which is placed said at least one temperature sensor, said thermal conductive layer being applied on the other face of the cold and hot faces of the Peltier module and being intended to be applied against one of the main faces of the microfluidic chip,
control means configured to control the power generator of the Peltier module depending on a temperature of the thermal regulation device and at least one temperature setting information selected from a target temperature and a target temporal temperature profile, and to regulate a temperature of the face of the Peltier module provided with said at least one temperature sensor to said at least one temperature setting information,
and said system being provided with a through hole traversing the optional thermal conductive layer, the Peltier module and the thermal regulation device, said hole having an axis perpendicular to the faces in contact of these elements.

2. Temperature controlling system according to claim 1, wherein the cold face of the Peltier module is applied against the thermal regulated face of the thermal regulation device.

3. Temperature controlling system according to claim 1, wherein the optional thermal conductive layer, the thermal regulation device and the Peltier module have faces in contact of same dimensions and form.

4. Temperature controlling system according to claim 1, wherein the thermal regulation device include:
a fluid reservoir for storing a heat transfer fluid,
a thermal regulation element inside which a channel or a chamber is embedded, said channel or chamber being in fluid communication with said fluid reservoir, one face of said thermal regulation element being the thermal regulated face applied against the hot face of the Peltier module, said thermal regulation element being provided with a traversing through hole, the axis of which is perpendicular to the thermal regulated faces,
flow control means for controlling the flow rate of the heat transfer fluid within said channel,
and the temperature of the thermal regulated device is the temperature of the fluid in the fluid reservoir.

5. Temperature controlling system according to claim 4, wherein the thermal regulation element present one or several of the following features:
the thermal regulation element is a block made of a thermal conductive material,
the thermal regulation element is made of a material chosen from aluminium and copper.

6. Temperature controlling system according to claim 1, wherein, when present, the thermal conductive layer is chosen from a plate made of a rigid material and a layer made of a soft material, optionally a plate made of copper.

7. Temperature controlling system according to claim 1, wherein, when present, the thermal conductive layer has a thickness, measured perpendicularly to the face of the Peltier module against which it is applied, equal or substantially equal to a thickness of said at least one temperature sensor.

8. Temperature controlling system according to claim 1, wherein, when present, the thermal conductive layer has a traversing hole in which is nested said at least one temperature sensor.

9. Temperature controlling system according to claim 1, wherein the temperature sensor is a resistance temperature detector, optionally made directly on the face of the Peltier Module.

10. Temperature controlling system according to claim 1, wherein the through hole has a defined size and form, optionally configured to apply a defined temperature gradient profile in a plane perpendicular to the axis of the hole and through said hole in that plane.

11. Temperature controlled microfluidic assembly comprising:
a microfluidic chip of the general form of a flat plate having two opposite main faces and in which is embedded at least one microchannel for receiving a substance,
at least one temperature controlling system according to claim 1, the face of the Peltier module thereof provided with said at least one temperature sensor, or the thermal conducting layer when present, being applied against one of the main faces of the microfluidic chip.

12. Temperature controlled microfluidic assembly according to claim 11, wherein said face of the Peltier module or the optional thermal conductive layer, recovers at least partly a monitoring area of the main face of the microfluidic chip.

13. Microfluidic apparatus for monitoring a substance present in a microfluidic chip of the general form of a flat plate having two opposite main faces and in which is embedded at least one microchannel for receiving the substance, comprising
at least one temperature controlling system according to claim 1, the face of the Peltier module thereof provided with said at least one temperature sensor optionally the thermal conductive layer thereof, being intended to be applied against one of the main faces of the microfluidic chip,
optionally at least one fluidic circuit intended to be connected to said at least one microchannel of the microfluidic chip and flow controlling means connected to said fluidic circuit for controlling a flow rate or pressure of the substance within said at least one microchannel, optional means connected to said fluidic circuit for measuring a pressure drop through said at least one microchannel,
means for analyzing the substance within said at least one microchannel,
control means for controlling said at least one temperature controlling system and said analyzing means, and optionally the flow controlling means.

14. Microfluidic apparatus according to claim 13, wherein said flow controlling means when present include at least one element connected to the fluidic circuit chosen from a flow monitor, a flow meter, a pressure monitor and a pressure sensor.

15. Method for monitoring a substance using the microfluidic apparatus of claim 13, and a microfluidic chip of the form of a flat plate having two opposite main faces and in which is embedded at least one microchannel for receiving the substance, comprising:
optionally calibrating the temperature controlling system,
placing one main face of the microfluidic chip in contact with the face of the Peltier module of said at least one temperature regulating system provided with said at least one temperature sensor, optionally with the thermal conductive layer of the temperature regulating system,
introducing said substance inside said at least one microchannel before placing the microfluidic chip or after connecting said at least one microchannel of the microfluidic chip to said at least one fluidic circuit,
setting the temperature of the thermal regulating device at a first value,
setting at least one temperature setting information selected from a target temperature and a target temporal temperature profile for the temperature of the face of the Peltier module of said at least one temperature regulating system provided with said at least one temperature sensor,
regulating the temperature of the face of the Peltier module of said at least one temperature regulating system provided with said at least one temperature sensor to said at least one temperature setting information by controlling the power generator of the Peltier module,
monitoring the substance using means for analyzing the substance within said at least one microchannel during the temperature regulating step, and optionally under flow rate or pressure control of said substance inside said at least one microchannel.
